(19) United States
(12) Patent Application Publication
(10) Pub. No.: US 2002/0111167 A1
(43) Pub. Date: Aug. 15, 2002

(54) System and method of providing voice and data features in a time division multiple access (TDMA) network

(75) Inventors: Binh Nguyen, Ville St-Laurent (CA); Donald Joong, Montreal (CA); Sven-Erik Larsson, Rigaud (CA)

Correspondence Address: ERICSSON RESEARCH CANADA, 8400 DECARIE BLVD., MONTREAL, QC, H4P 2N2, CA

(73) Assignee: Telefonaktiebolaget LM Ericsson (publ).

(21) Appl. No.: 09/783,818

(22) Filed: Feb. 13, 2001

(51) Int. Cl. H04Q 7/20

(52) U.S. Cl. 455/435; 455/466; 455/458; 455/433; 455/426

(57) ABSTRACT

A system and method of providing voice and data feature interaction in a Time Division Multiple Access (TDMA) radio telecommunication network having a data network overlay. An incoming voice call is established with a called mobile station (MS) when the called MS is operating in a data mode. An indicator is set in the called MS's user profile indicating that the called MS is operating in the data mode. The called MS is notified through the data network overlay that the incoming voice call is waiting. If the call is accepted, it is delivered to the called MS. The system may also establish an incoming data call with the called MS when the called MS is operating in a voice mode. A Short Message Service message center notifies the called MS that a data call is waiting. If the call is accepted, it is delivered to the called MS.

### BACKGROUND OF THE INVENTION

1. Technical Field of the Invention

This invention relates to telecommunication systems and, more particularly, to a system and method of providing voice and data features in a Time Division Multiple Access (TDMA) radio telecommunication network.

2. Description of Related Art

In TDMA radio telecommunications networks, voice and data are handled in two different networks; a circuit-switched voice network is overlain by a packet-switched data network. For example, a Cellular Digital Packet Data (CDPD) network may overlay the voice network. If a mobile subscriber desires to utilize the voice network, he places his Mobile Station (MS) in voice mode, and the MS performs a standard registration procedure with the voice network. If the subscriber then desires to send a data message, he places his MS in data mode. The MS sends a power-down registration message to the voice network and then performs an attach or registration procedure with the data network. The data message can then be sent. However, since the MS has de-registered with the voice network, any incoming voice calls to the MS at that time are automatically diverted to voice mail, if available, or if voice mail is not available, an announcement is sent to the calling party stating that the mobile subscriber is not available.

There is no interaction between the voice network and the data network. Even though the two networks are using the same frequency bands, they are using different channels. Therefore, the MS cannot receive a voice call when it is in data mode, and cannot receive a data call when it is in voice mode. For example, if a mobile subscriber is conducting a voice call in the voice network, and an e-mail or any other data message is sent to him, the subscriber does not receive the message or any indication that a data message is waiting. Thus, if there is an urgent call for the mobile subscriber, the calling party must know whether the MS is in data mode or voice mode, and the MS must be contacted in the mode in which it is currently operating.

It would be advantageous to have a system and method of providing voice and data features in TDMA networks that enables the MS to be reached by a data message when the subscriber is on a voice call, and by a voice message when the subscriber is on a data call. It would also be advantageous for an indication to be provided to the subscriber that a call in the other mode is being received. The subscriber may then leave the mode he is in and take the incoming call. He can then go back and finish the ongoing call in the original mode. The present invention provides such a system and method.

### SUMMARY OF THE INVENTION

In one aspect, the present invention is a method of setting up an incoming voice call from a calling party to a called mobile station (MS) that is operating in a data mode in a radio telecommunications network having a voice network portion and a data network overlay. Although the embodiment described herein illustrates the calling party as being a calling MS, it should be recognized that the calling party may also use a wireline phone or data terminal. The voice network portion includes a first Mobile Switching Center (MSC-1) serving the called MS, a Home Location Register (HLR) for the called MS, and a second MSC (MSC-2) serving the calling MS. The data network overlay includes a Mobile Data Immediate System (MDIS) serving the called MS and a gateway connecting the MDIS to an Internet Protocol (IP) network. The method retains an active user record in the HLR for the called MS when the called MS switches from a voice mode to a data mode. The record indicates that the called MS is operating in the data mode. This is followed by notifying the called MS that the incoming voice call is waiting, determining whether the called MS accepted the incoming voice call, and delivering the incoming voice call to the called MS upon determining that the called MS accepted the incoming voice call. The method also prevents a call-setup timer in MSC-2 from expiring while notifying the called MS that the incoming voice call is waiting and determining whether the called MS accepted the incoming voice call.

In another aspect, the present invention is a method of setting up an incoming data call from a calling MS to a called MS that is operating in a voice mode in a radio telecommunications network. The method includes the steps of receiving the incoming data call in an application server in the data network overlay, and sending a data waiting message from the application server to a message center (MC) in the voice network. The MC then sends a Short Message Service (SMS) message containing a Data Waiting Indicator (DWI) to the called MS. This is followed by determining whether the called MS accepted the incoming data call, and routing the incoming data call to the called MS upon determining that the called MS accepted the incoming data call.

In yet another aspect, the present invention is a system for setting up an incoming voice call from a calling MS to a called MS that is operating in a data mode in a radio telecommunications network having a voice network portion and a data network overlay. The system includes an indicator in a user record in the HLR for the called MS that indicates that the called MS is operating in the data mode, and a voice/data application server in the data network overlay that receives a notification from the HLR that the voice call is waiting, and sends the notification through the data network overlay to the called MS. The system also includes a signaling mechanism in the HLR that receives a registration message from the called MS indicating that the called MS accepted the incoming voice call, and call processing logic in the HLR that prevents a call-setup timer in MSC-2 from expiring while the incoming voice call is being set up. The logic sends a first response message to MSC-2 instructing MSC-2 to suspend the timer until a second response message is received. After the called MS accepts the voice call, a signaling mechanism in the HLR obtains a routing number for the called MS from MSC-1, and returns the routing number to MSC-2 in the second response message.

In yet another aspect, the present invention is a system for setting up an incoming data call from a calling MS to a called MS that is operating in a voice mode in a radio telecommunications network having a voice network portion and a data network overlay. The system includes a message center (MC) that sends an SMS message containing a Data Waiting Indicator (DWI) to the called MS, and a signaling mechanism in MDIS-1 for receiving a registration message from the called MS indicating that the called MS accepted the incoming data call, and for sending the registration message to a voice/data application server in the data network. The voice/data application server in the data network overlay receives the incoming data call from MDIS-2 and sends a data waiting message to the MC. The application server also routes the incoming data call to the called MS after the registration message indicates that the called MS accepted the incoming data call.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a simplified block diagram of an existing TDMA network with a data network overlay;

FIG. 2 is a simplified block diagram of the preferred embodiment of the system of the present invention;

FIG. 3 is a signaling diagram illustrating the flow of messages between nodes in the radio telecommunications network when an MS is in data mode and a voice message is received, in accordance with the teachings of the present invention; and

FIG. 4 is a signaling diagram illustrating the flow of messages between nodes in the radio telecommunications network when an MS is in voice mode and a data message is received, in accordance with the teachings of the present invention.

### DETAILED DESCRIPTION OF EMBODIMENTS

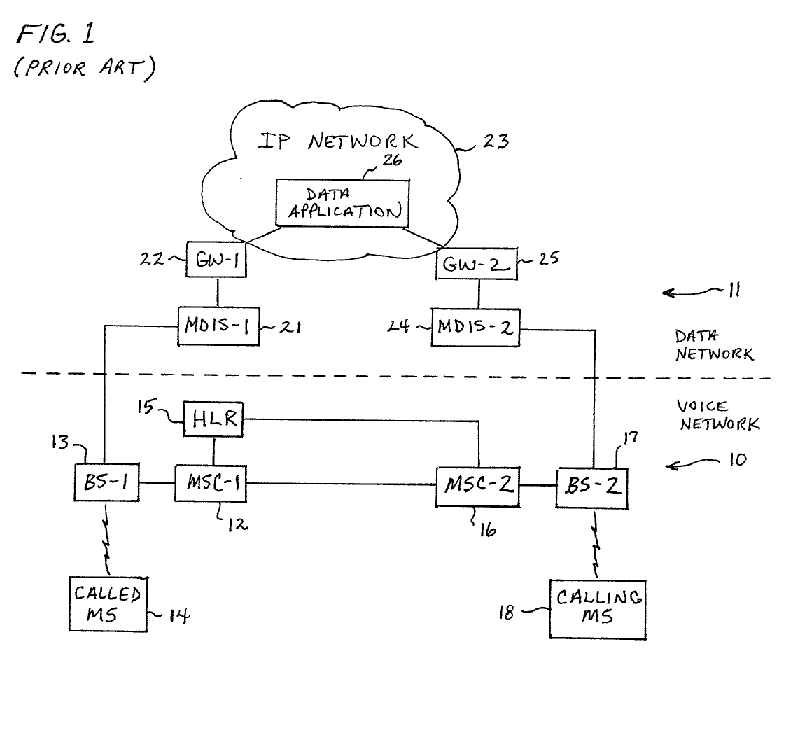

FIG. 1 is a simplified block diagram of an existing TDMA network 10 with a data network overlay 11. The voice network includes a first Mobile Switching Center (MSC-1) 12 that communicates through a first Base Station (BS-1) 13 with a called MS 14. The called MS has a Home Location Register (HLR) 15 that stores the called MS's user profile, status, and location information. A second MSC (MSC-2) 16 communicates through a second Base Station (BS-2) 17 with a calling MS 18. When the called MS switches to voice mode, it registers with the HLR. Thereafter, when the calling MS places a voice call to the called MS, MSC-2 queries the HLR for location information. The HLR obtains a routing number from MSC-1 and returns the routing number to MSC-2. The voice call is then set up.

On top of the voice network 10 is the data network overlay 11 which may be, for example, a Cellular Digital Packet Data (CDPD) network. The data network may include a first Mobile Data Immediate System (MDIS-1) 21 which performs server functions for the called MS 14 in the data network. Like MSC-1 12, the MDIS-1 is also connected to BS-1 13, but is on a different control channel. MDIS-1 is on a data control channel while MSC-1 is on a voice control channel. A first Gateway (GW-1) 22 connects MDIS-1 to an Internet Protocol (IP) network 23.

In a similar manner, the calling MS 18 may be connected to the IP network 23. A second MDIS (MDIS-2) 24 is connected to BS-2 17 on a data control channel. A second Gateway (GW-2) 25 connects MDIS-2 to the IP network. Within the IP network, a data application 26 enables data to be transferred between the calling MS 18 and the called MS 14 when the two MSs are in data mode.

If the called MS 14 is operating in voice mode, and then switches to data mode, the called MS performs an attach or registration procedure with MDIS-1 21 so that the called MS can send and receive data messages through the IP network. The called MS also sends a power-down registration message over the air interface to BS-1 13 and MSC-1 12. This message is sent as an ANSI-41 Registration Cancellation (REGCAN) message from MSC-1 to the HLR 15 to cancel the called MS's registration in the voice network. Thereafter, the user profile in the HLR indicates that the called MS is not registered (i.e., the called MS is off). Thus, if the calling MS 18 then attempts to place a voice call to the called MS while it is in data mode, the call is immediately routed to voice mail, or the calling MS automatically receives a voice announcement that the subscriber is not available because the called MS has canceled its registration with the HLR.

Likewise, if the called MS 14 is operating in data mode, and then switches to voice mode, the called MS cancels its registration with the data network and sends a Registration message to the HLR 15 to register in the voice network. Thereafter, if the calling MS 18 attempts to place a data call to the called MS while it is in voice mode, the data network has no knowledge of the called MS, and the data call fails.

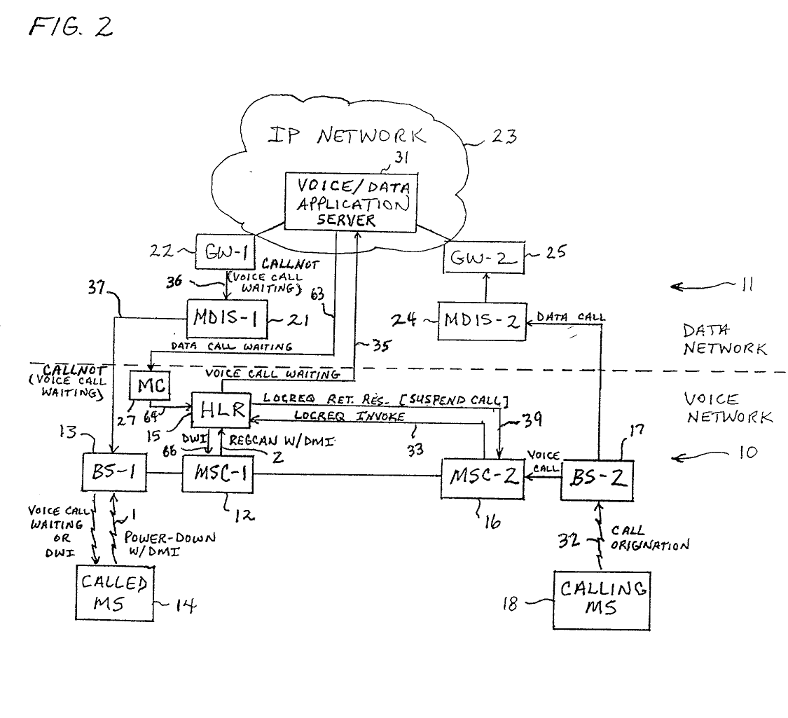

FIG. 2 is a simplified block diagram of the preferred embodiment of the system of the present invention. FIG. 2 illustrates modifications to the voice and data networks required to provide an indication to the called MS 14 that a voice call is waiting, after the called MS has switched from the voice mode to the data mode. In addition, the system provides an indication to the called MS that a data call is waiting, when the called MS is operating in the voice mode. Although the embodiment described herein illustrates the calling party as being a calling MS, it should be recognized that the calling party may also use a wireline phone or data terminal.

Scenario 1: MS in Data Mode Receives Voice Call

When the called MS switches from the voice mode to the data mode, it sends an IS-136 power-down registration message 1 to BS-1 13. The present invention modifies this message to include a Data Mode Indicator (DMI) that indicates that the called MS is switching to the data mode rather than shutting down. The power-down registration message with DMI is sent to MSC-1 12 which adds a new field to the ANSI-41 Registration Cancellation (REGCAN) message 2 to include the DMI, and sends the modified REGCAN message to the HLR 15. The HLR puts the called MS in a new state called “data” in the user profile to indicate that the called MS is operating in the data mode.

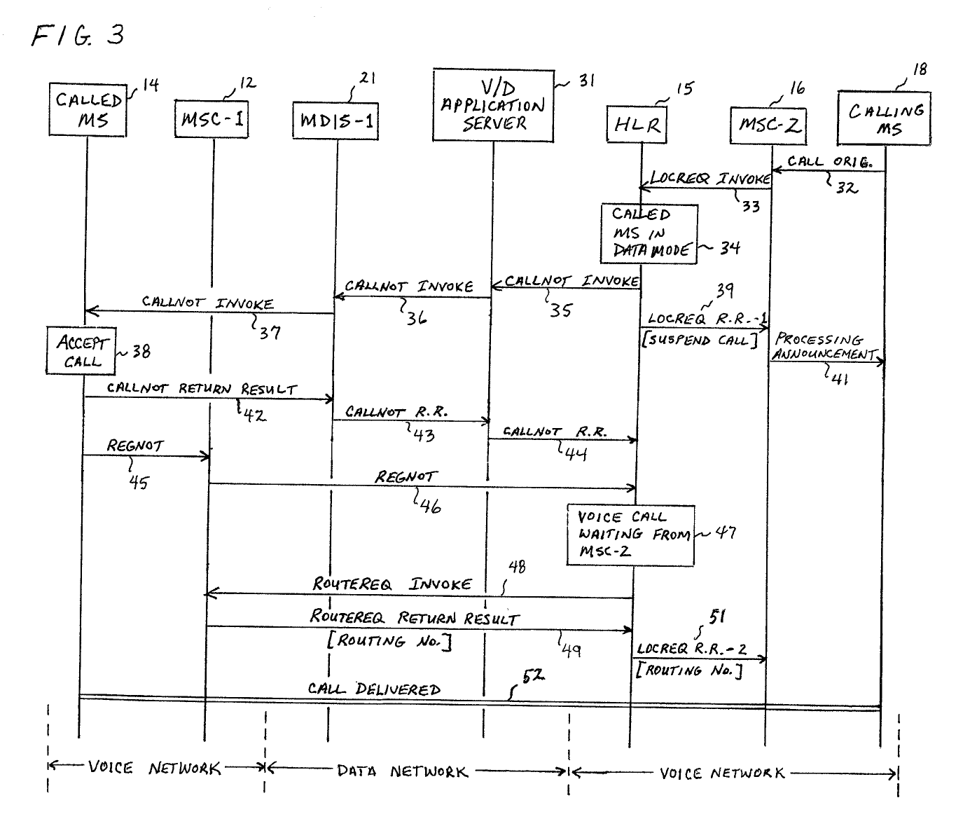

FIG. 3 is a signaling diagram illustrating in more detail, the flow of messages between the nodes of the radio telecommunications network in the scenario in which an MS is in data mode and a voice message is received. Therefore, with reference to both FIG. 2 and FIG. 3, the remainder of the process will be described. When the calling MS 18 originates a voice call 32 toward the called MS 14, MSC-2 16, which is serving the calling MS, sends a Location Request (LOCREQ) Invoke message 33 to the HLR 15. The HLR first looks for the DMI in the subscriber profile. If no DMI was received with the REGCAN message 2, the HLR responds to the interrogating MSC-2 that the called MS is inactive. If a DMI was received, the HLR takes steps in accordance with the present invention to notify the called MS that there is an incoming voice call.

While these steps are taken, other steps must be taken to prevent the voice call from timing out. In ANSI-41 call processing, a call-setup timer in MSC-2 16 may time out if the setup takes too long. Therefore, the timer in MSC-2 is suspended by sending a first LOCREQ Return Result message 39 from the HLR 15 to MSC-2 that includes a new indication that call setup may be delayed because the called MS 14 is in data mode. MSC-2 may then suspend the timer and optionally send an announcement 41 to the calling MS 18 that the call is being processed. MSC-2 then waits for a follow-up LOCREQ Return Result message 51 from the HLR with routing information.

In order to notify the called MS that there is an incoming voice call, the HLR 15 sends a Call Notification (CALLNOT) Invoke message 35 with an indication that a voice call is waiting to a Voice/Data (V/D) application server 31 in the IP network. At 36 and 37, a CALLNOT Invoke message is sent from the V/D application server through GW-1 22 and MDIS-1 21 to the called MS 14 indicating that a voice call is waiting. The called subscriber may then choose to accept the voice call or reject it at 38.

If the called subscriber rejects the voice call, the called MS sends a CALLNOT Return Result message 32-34 back through MDIS-1 21 and the V/D application server 31 to the HLR 15 with an indication that the voice call is rejected. The HLR then sends a follow-up LOCREQ Return Result message 51 to MSC-2 16 indicating that the voice call has been rejected. The call may then be routed to voice mail, or an announcement made to the calling MS that the called MS is not available. If the called subscriber ignores the voice call indication, a call setup timer in the V/D application server will expire. The V/D application server then notifies the HLR that the call has timed out, and the HLR sends the follow-up LOCREQ Return Result message to MSC-2 indicating that the call has not been accepted. The call may then be routed to voice mail, or an announcement made to the calling MS that the called MS is not available.

If the called subscriber accepts the voice call at 38, he switches the called MS to voice mode. At 42 and 43, an indication of this switch is sent to the V/D application 31 in the CALLNOT Return Result message. If a data call was in progress, the V/D application server places the data call on hold. At 45 and 46, the called MS then re-registers with the HLR through MSC-1 12. The HLR recognizes from its database that it has sent the first LOCREQ Return Result message 39 to MSC-2 16 to suspend the voice call, and that the called MS has a voice call waiting. Normal call-setup procedures are then followed to obtain a routing number from MSC-1 and return the routing number to MSC-2 in the follow-up LOCREQ Return Result message 51. The voice call is then delivered to the called MS at 52.

When the voice call is completed, the called subscriber may switch back to data mode to resume the data call. An attach or registration procedure is begun, and MDIS-1 21 recognizes that there is a call on hold for the called MS. The voice/data application is then notified that the called MS is back in data mode, and the data call is continued.

Referring now to FIG. 3, the signal flow depicted in FIG. 2 will be discussed in more detail. As noted above, when the called MS 14 switches from the voice mode to the data mode, the DMI is sent in the REGCAN message to the HLR 15, and the HLR puts the called MS in a new state called “data” in the user profile to indicate that the called MS is operating in the data mode. Thereafter, the calling MS 18 originates a voice call at 32 toward the called MS 14. MSC-2 16, which is serving the calling MS, sends a LOCREQ Invoke message 33 to the HLR 15. The HLR looks for the DMI in the user profile at 34 and determines that the called MS is in the data mode.

In order to notify the called MS that there is an incoming voice call, the HLR 15 sends the CALLNOT Invoke message 35 to the V/D application server 31 in the IP network with an indication that a voice call is waiting. At 36 and 37, the CALLNOT message is routed from the V/D application server through MDIS-1 21 to the called MS 14. The called subscriber may then choose to accept the voice call or reject it at 38.

While these steps are taken, other steps must be taken to prevent the voice call from timing out. Therefore, the timer in MSC-2 is suspended by sending a first LOCREQ Return Result message (LOCREQ R.R.-1) 39 from the HLR 15 to MSC-2 that indicates that call setup may be delayed because the called MS 14 is in data mode. MSC-2 may then suspend the timer and send a notification or announcement 41 to the calling MS 18 that the call is being processed. MSC-2 then waits for a follow-up LOCREQ Return Result message from the HLR with routing information.

When the called subscriber accepts the voice call, he switches the called MS to voice mode. The called MS sends a CALLNOT Return Result message 42 to MDIS-1 21. At 43 and 44, the CALLNOT Return Result message is forwarded to the V/D application 31 and the HLR 15. If a data call was in progress, the V/D application server places the data call on hold. The called MS then sends a Registration Notification (REGNOT) message 45 to MSC-1 12 which forwards it to the HLR at 46. At 47, the HLR recognizes from its database that it has sent the first LOCREQ Return Result message to MSC-2 16 to suspend the voice call, and that the called MS has a voice call waiting. Therefore, the HLR sends a Routing Request (ROUTEREQ) Invoke message 48 to MSC-1 which returns a routing number in a ROUTEREQ Return Result message 49. The HLR then sends the routing number to MSC-2 in the follow-up LOCREQ Return Result message (LOCREQ R.R.-2) 51. The voice call is then delivered to the called MS at 52.

Scenario 2: MS in Voice Mode Receives Data Call

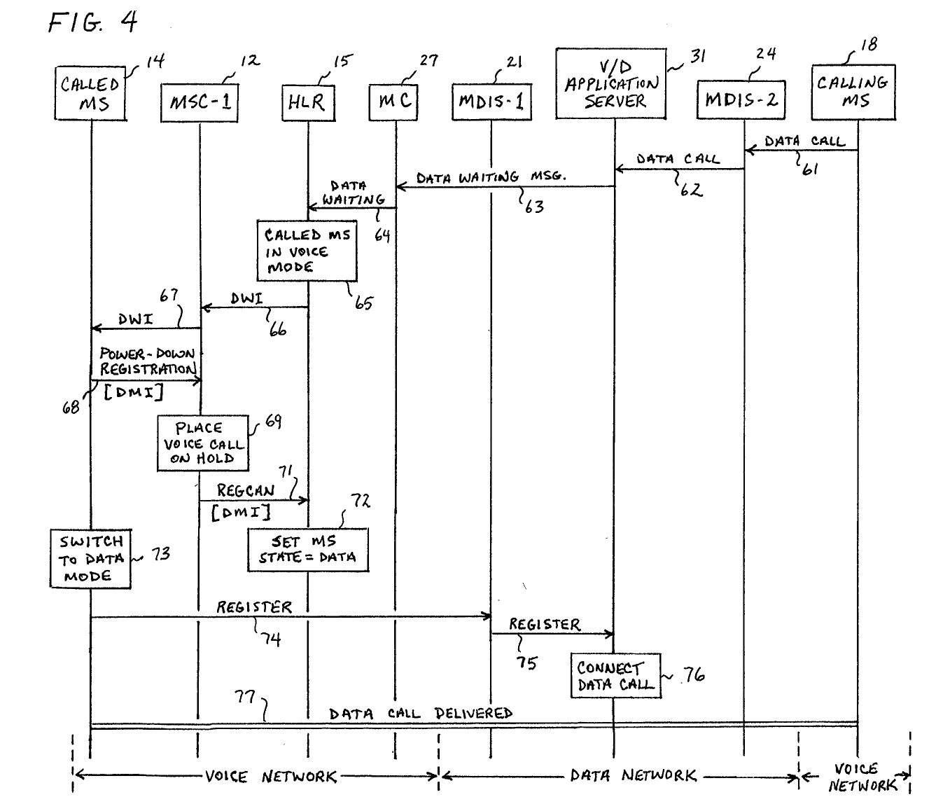

FIG. 4 is a signaling diagram illustrating the flow of messages between nodes in the radio telecommunications network when an MS is in voice mode and a data message is received, in the preferred embodiment of the method of the present invention. For this scenario, an existing application such as Short Message Service (SMS) is utilized to send a Data Waiting Indicator (DWI) from a Message Center (MC) 27 to the called MS 14. The calling MS 18 originates a data call toward the called MS at 61. At 62, the data call is routed by MDIS-2 24 to the V/D application server 31. The V/D application server sends a Data Waiting message 63 to the MC indicating that the data call is waiting, and the MC forwards the message at 64 to the HLR 15. At 65, the HLR determines from the user profile that the called MS is in the voice mode. Therefore, at 66, the HLR sends a DWI to MSC-1 12 indicating that a data call for the called MS is waiting. At 67, the MSC-1 then sends an SMS message to the called MS with the DWI. The called subscriber may then choose to accept it or reject it.

If the called subscriber accepts the data call, the called MS 14 sends a power-down registration message 68 to MSC-1 12. The power-down registration message includes the Data Mode Indicator (DMI). At 69, MSC-1 places any ongoing voice call on hold, and at 71, sends a REGCAN message with the DMI to the HLR 15. At 72, the HLR then sets the state of the called MS to “data” in the user profile.

At 73, the called MS 14 then completes the switch to data mode, and registers with MDIS-1 21 at 74. At 75, the MDIS-1 forwards the registration to the V/D application server 31. The V/D application server then connects the data call at 76, and at 77 the data call is delivered.

When the data call is completed, the called subscriber may switch back to voice mode to resume the voice call. A Registration procedure is begun, and MSC-1 recognizes that there is a voice call on hold for the called MS. The MSC-1 then reconnects the voice call, and the voice call is continued.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A method of retaining an active subscriber record in a Home Location Register (HLR) for a mobile station operating in a radio telecommunications network when the mobile station switches from a voice mode to a data mode, said method comprising the steps of:
transmitting from the mobile station to a serving base station, a power-down registration message that includes a Data Mode Indicator (DMI);
sending the power-down registration message and DMI from the base station to a serving Mobile Switching Center (MSC);
sending from the MSC to the HLR, a registration cancellation message that includes the DMI; and
in response to receiving the DMI, setting an indicator in the subscriber record in the HLR indicating that the mobile station is operating in the data mode.

2. A method of preventing a call-setup timer in an interrogating Mobile Switching Center (MSC) from expiring when an incoming voice call is made to a called mobile station (MS) that is operating in a data mode in a radio telecommunications network having a voice network portion and a data network overlay, said voice network portion including a Home Location Register (HLR) for the called MS, said method comprising the steps of:
setting an indicator in the HLR indicating that the called MS is operating in the data mode;
receiving in the interrogating MSC, the voice call from the calling MS;
sending a location request message from the interrogating MSC to the HLR;
determining from the indicator in the HLR that the called MS is operating in the data mode;
sending from the HLR to the interrogating MSC, a first response to the location request message, said first response directing the interrogating MSC to wait for a second response; and
suspending the call-setup timer in the interrogating MSC.

3. The method of claim 2 wherein the step of setting an indicator in the HLR indicating that the called MS is operating in the data mode includes receiving in the HLR a Data Mode Indicator (DMI) from the called MS, said DMI being sent by the called MS when switching to the data mode.

4. A method of notifying a called mobile station (MS) that an incoming voice call from a calling MS is waiting when the called MS is operating in a data mode in a radio telecommunications network having a voice network portion and a data network overlay, said voice network portion including a Home Location Register (HLR) for the called MS, said method comprising the steps of:
setting an indicator in the HLR indicating that the called MS is operating in the data mode;
sending a location request message from an interrogating Mobile Switching Center (MSC) to the HLR;
determining from the indicator in the HLR that the called MS is operating in the data mode; and
sending from the HLR through the data network overlay to the called MS, an indication that the voice call is waiting.

5. The method of claim 4 wherein the step of setting an indicator in the HLR indicating that the called MS is operating in the data mode includes receiving in the HLR a Data Mode Indicator (DMI) from the called MS, said DMI being sent by the called MS when switching to the data mode.

6. The method of claim 4 further comprising preventing a call-setup timer in the interrogating MSC from expiring while the indication that the voice call is waiting is sent to the called MS.

7. The method of claim 6 wherein the step of preventing the call-setup timer from expiring includes the steps of:
sending from the HLR to the interrogating MSC, a first response to the location request message, said first response directing the interrogating MSC to wait for a second response; and
suspending the call-setup timer in the interrogating MSC.

8. A method of setting up an incoming voice call from a calling mobile station (MS) to a called MS that is operating in a data mode in a radio telecommunications network having a voice network portion and a data network overlay, said voice network portion including a first Mobile Switching Center (MSC-1) serving the called MS, a Home Location Register (HLR) that stores a user record for the called MS, and a second MSC (MSC-2) serving a calling MS, and said data network overlay including a Mobile Data Immediate System (MDIS) serving the called MS and a gateway connecting the MDIS to an Internet Protocol (IP) network, said method comprising the steps of:
notifying the called MS that the incoming voice call is waiting;
determining whether the called MS accepted the incoming voice call;
preventing a call-setup timer in MSC-2 from expiring while notifying the called MS that the incoming voice call is waiting and while determining whether the called MS accepted the incoming voice call; and
delivering the incoming voice call to the called MS upon determining that the called MS accepted the incoming voice call.

9. The method of claim 8 further comprising the step of retaining an active user record in the HLR for the called MS when the called MS switches from a voice mode to the data mode, said record indicating that the called MS is operating in the data mode.

10. The method of claim 9 wherein the step of retaining an active user record in the HLR for the called MS includes the steps of:
transmitting from the mobile station to a serving base station, a power-down registration message that includes a Data Mode Indicator (DMI);
sending the power-down registration message and DMI from the base station to MSC-1;
sending from MSC-1 to the HLR, a registration cancellation message that includes the DMI; and
in response to receiving the DMI, setting an indicator in the user record in the HLR indicating that the mobile station is operating in the data mode.

11. The method of claim 8 wherein the step of notifying the called MS that the incoming voice call is waiting includes the steps of:
determining from the user record in the HLR that the called MS is operating in the data mode; and
sending from the HLR through the data network overlay to the called MS, an indication that the voice call is waiting.

12. The method of claim 8 wherein the step of preventing a call-setup timer in MSC-2 from expiring includes the steps of:
receiving in MSC-2, the voice call from the calling MS;
sending a location request message from MSC-2 to the HLR;
determining from the user record in the HLR that the called MS is operating in the data mode;
sending from the HLR to MSC-2, a first response to the location request message, said first response directing MSC-2 to wait for a second response; and
suspending the call-setup timer in MSC-2.

13. The method of claim 8 further comprising placing an ongoing data call on hold upon determining that the called MS accepted the incoming voice call.

14. The method of claim 13 further comprising the steps of:
determining that the called MS is switching back to the data mode; and
reconnecting the ongoing data call on hold.

15. A method of setting up an incoming voice call from a calling mobile station (MS) to a called MS that is operating in a data mode in a radio telecommunications network having a voice network portion and a data network overlay, said voice network portion including a first Mobile Switching Center (MSC-1) serving the called MS, a Home Location Register (HLR) for the called MS, and a second MSC (MSC-2) serving a calling MS, and said data network overlay including a Mobile Data Immediate System (MDIS) serving the called MS and a gateway connecting the MDIS to an Internet Protocol (IP) network, said method comprising the steps of:
setting an indicator in the HLR indicating that the called MS is operating in the data mode;
receiving in MSC-2, the voice call from the calling MS;
sending a location request message from MSC-2 to the HLR;
determining from the indicator in the HLR that the called MS is operating in the data mode;
sending from the HLR through the data network overlay to the called MS, an indication that the voice call is waiting;
sending from the HLR to the interrogating MSC, a first response to the location request message, said first response directing the interrogating MSC to wait for a second response;
suspending the call-setup timer in the interrogating MSC;
determining by a voice/data application server in the data network overlay, whether the called MS accepted the incoming voice call;
placing an ongoing data call on hold by the application server, upon determining that the called MS accepted the incoming voice call;
determining by the HLR, whether the called MS accepted the incoming voice call; and
upon determining that the called MS accepted the incoming voice call:
obtaining by the HLR, a routing number for the called MS from MSC-1;
sending a second response to MSC-2, said second response including the routing number for the called MS; and
routing the voice call to the called MS.

16. The method of claim 15 wherein the step of determining whether the called MS accepted the incoming voice call includes receiving in the HLR, a registration message from the called MS.

17. The method of claim 15 wherein the step of determining whether the called MS accepted the incoming voice call includes receiving in the HLR, an indication from the called MS, routed through the MDIS and gateway, that the called MS did not accept the incoming voice call.

18. The method of claim 17 further comprising, upon determining that the called MS did not accept the incoming voice call, sending a second response to MSC-2, said second response including an indication that the called MS did not accept the incoming voice call.

19. A method of setting up an incoming data call from a calling mobile station (MS) to a called MS that is operating in a voice mode in a radio telecommunications network having a voice network portion and a data network overlay, said voice network portion including a first Mobile Switching Center (MSC-1) serving the called MS, a Home Location Register (HLR) for the called MS, and a second MSC (MSC-2) serving a calling MS, and said data network overlay including a Mobile Data Immediate System (MDIS) serving the called MS and a gateway connecting the MDIS to an Internet Protocol (IP) network, said method comprising the steps of:
sending a Short Message Service (SMS) message containing a Data Waiting Indicator (DWI) to the called MS;
determining whether the called MS accepted the incoming data call; and
routing the incoming data call to the called MS upon determining that the called MS accepted the incoming data call.

20. The method of claim 19 further comprising, before the step of sending an SMS message, the steps of:
receiving the incoming data call in an application server in the data network overlay; and
sending a data waiting message from the application server to a message center (MC) in the voice network portion.

21. The method of claim 19 further comprising placing an ongoing voice call on hold upon determining that the called MS accepted the incoming data call.

22. The method of claim 21 further comprising the steps of:
determining that the called MS is switching back to the voice mode; and
reconnecting the ongoing voice call on hold.

23. A system for setting up an incoming voice call from a calling mobile station (MS) to a called MS that is operating in a data mode in a radio telecommunications network having a voice network portion and a data network overlay, said voice network portion including a first Mobile Switching Center (MSC-1) serving the called MS, a Home Location Register (HLR) for the called MS, and a second MSC (MSC-2) serving a calling MS, and said data network overlay including a Mobile Data Immediate System (MDIS) serving the called MS and a gateway connecting the MDIS to an Internet Protocol (IP) network, said system comprising:
an indicator in a user record in the HLR for the called MS that indicates that the called MS is operating in the data mode;
a voice/data application server in the data network overlay that receives a notification from the HLR that the voice call is waiting, and sends the notification through the data network overlay to the called MS;
a signaling mechanism in the HLR that receives a registration message from the called MS indicating that the called MS accepted the incoming voice call;
call processing logic in the HLR that prevents a call-setup timer in MSC-2 from expiring while the called MS is notified that the incoming voice call is waiting, and while it is determined whether the called MS accepted the incoming voice call, said logic sending a first response message to MSC-2 instructing MSC-2 to suspend the timer until a second response message is received; and
a signaling mechanism in the HLR for obtaining a routing number for the called MS from MSC-1, and returning the routing number to MSC-2 in the second response message.

24. A system for setting up an incoming data call from a calling mobile station (MS) to a called MS that is operating in a voice mode in a radio telecommunications network having a voice network portion and a data network overlay, said voice network portion including a first Mobile Switching Center (MSC-1) serving the called MS, a Home Location Register (HLR) for the called MS, and a second MSC (MSC-2) serving a calling MS, and said data network overlay including a Mobile Data Immediate System (MDIS) serving the called MS and a gateway connecting the MDIS to an Internet Protocol (IP) network, said system comprising:
a message center that sends a Short Message Service (SMS) message containing a Data Waiting Indicator (DWI) to the called MS;
a signaling mechanism in MDIS-1 for receiving a registration message from the called MS, and for sending the registration message to a voice/data application server in the data network, said registration message indicating that the called MS accepted the incoming data call; and
a voice/data application server in the data network overlay that receives the incoming data call from MDIS-2 and sends a data waiting message to the MC, said application server also routing the incoming data call to the called MS after the registration message indicates that the called MS accepted the incoming data call.
